(19) United States
(12) Patent Application Publication
(10) Pub. No.: US 2022/0303158 A1
(43) Pub. Date: Sep. 22, 2022

(54) END-TO-END CHANNEL ESTIMATION IN COMMUNICATION NETWORKS

(71) Applicant: NEC Laboratories Europe GmbH, Heidelberg (DE)

(72) Inventor: Francesco Alesiani, Heidelberg (DE)

(21) Appl. No.: 17/348,830

(22) Filed: Jun. 16, 2021

Related U.S. Application Data
(60) Provisional application No. 63/163,121, filed on Mar. 19, 2021.

(51) Int. Cl. H04L 25/02

(52) U.S. Cl. CPC H04L 25/0254

(57) ABSTRACT

A method for an end-to-end system for channel estimation includes obtaining data associated with a communication system. The communication system comprises a receiver, a transmitter, and a communication channel. A neural network is trained that models the communication channel of the communication system and this training is based on inputting the obtained data into the neural network and using a decoder. The neural network produces an output indicating a probability of a signal from the communication channel. The trained neural network is used for decoding information from the communication channel.

### CROSS-REFERENCE TO PRIOR APPLICATION

Priority is claimed to U.S. Provisional Application No. 63/163,121 filed on Mar. 19, 2021, the entire contents of which is hereby incorporated by reference herein.

### FIELD

The present invention relates to communication networks, and in particular to a method, system and computer-readable medium for predicting transmission channel parameters, and for training a communication system to predict such transmission channel parameters.

### BACKGROUND

Communication systems are used for the transmission of information and impact everyday life. Digital transmission over channels of communication systems is based on the ability to recover the transmitted message when the signal transmitted undergoes channel distortion and noise. Examples of communication networks that include digital transmission channels include: 1) mobile communication network (radio link); 2) backbone networks of a mobile network (fiber optic); 3) submarine or long distance communication networks; 4) space communication networks; and 5) interspace/satellite communication networks.

EP 0904649, which is hereby incorporated by reference herein, describes a maximum likelihood sequence estimation (MLSE) decoder with a neural network.

### SUMMARY

In an embodiment, the present invention provides a method for an end-to-end system for channel estimation. The method comprises: obtaining data associated with a communication system, wherein the communication system comprises a receiver, a transmitter, and a communication channel; training a neural network that models the communication channel of the communication system based on inputting the obtained data into the neural network and using a decoder, wherein the neural network produces an output indicating a probability of a signal from the communication channel; and using the trained neural network for decoding information from the communication channel.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates an exemplary communication system with a communication channel;

FIG. 2 schematically illustrates a method and system for training of an end-to-end communication system with a decoder according to an embodiment of the present invention;

FIG. 3 schematically illustrates a method and system for deploying a trained end-to-end communication system with a decoder according to an embodiment of the present invention;

FIG. 4 schematically illustrates a forward looking (auto-regressive) network and a standard convolution network;

FIG. 5 schematically illustrates a communication variational auto-encoder (VAE) within a training environment according to an embodiment of the present invention;

FIG. 6 schematically illustrates a communication VAE during deployment according to an embodiment of the present invention;

FIG. 7 schematically illustrates a method and system for training of a communication generative adversarial neural network according to an embodiment of the present invention;

FIG. 8 schematically illustrates a method and system for deploying a trained communication generative adversarial neural network according to an embodiment of the present invention;

FIG. 9 schematically illustrates a method and system for communication channel encoding and decoding according to an embodiment of the present invention;

FIG. 10 schematically illustrates a method and system to transfer estimated channel parameters according to an embodiment of the present invention; and

FIG. 11 schematically illustrates an example network protocol of channel estimation according to an embodiment of the present invention.

### DETAILED DESCRIPTION

Traditional methods, which have been developed, address the channel estimation and symbol recovery separately. Shlezinger, Nir, et al., “ViterbiNet: A Deep Learning Based Viterbi Algorithm for Symbol Detection,” ArXiv:1905.10750 (Sep. 29, 2020), which is hereby incorporated by reference herein, discuss an approach that attempts to apply machine learning. However, there is still a lack of a proper approach. Therefore, in contrast to existing approaches, embodiments of the present invention provide an end-to-end learnable system for learning channel(s) and decoding that provides for a number of improvements to the communication system itself. The end-to-end system of the present invention may be trained such that the training is not done at each component separately, but rather, the error at an output is propagated to all of the components within the system. By doing this, each component may be differentiable and/or have a “surrogate” gradient and/or an estimate of the gradient.

For example, in an embodiment, the present invention provides a method to train an end-to-end transmission system to estimate the channel parameters, which incorporates a decoder in the training phase. The method may be advantageously applied to reduce preamble (pilot signal) length and thereby improve communication efficiency and reduce error rate. The method also provides for more flexible architecture for the design of the transmitter and receiver system.

In other words, the present invention may improve the ability to model the transmission channels correctly, which may improve the performance and/or efficiency within communication systems, especially in communication systems with variant channels. In some instances, the method provides an end-to-end training system for channel estimation, which may lead to better decoding, lower error rates, and more efficient transmission. For example, the present invention may allow for a shorter pilot signal that still provides the same and/or even improved performance (e.g., error rate) of the communication system. Additionally, and/or alternatively, the present invention may permit for more flexible architectures to model the communication channel.

In other words, traditionally, a communication channel may be estimated using pre-ambles of known symbols that are sent to the channel to estimate the channel response. In contrast, using the present invention, the time to identify the channel is reduced by pre-training or by using information from other devices (e.g., transmitters and/or receivers). Using a pre-trained network, the system of the present invention provides already determined estimations of the parameters from the received signals without pre-ambles. In an embodiment, the online version may allow improvement of the parameter estimation based on successfully decoded messages. Additionally, and/or alternatively, by using the generative adversarial neural network (GAN), the probability of the symbols are used in the decoding process, also with small or no pre-amble symbols.

In embodiments with a varying channel, the network of the present invention may react quickly to known situations close to the training scenario and since the network may be updated based on the local condition, the network parameters may be shared to allow fast response to the local environment. For example, a network model may be updated for a local transmitter in a room with various obstacles or in an urban scenario. Additional information as input features as the location of the receiver may further improve the performances. This information may be included in the training phase giving a location aware channel model. In instances when the receiver is inside a building or in an open road, the network may provide a more tailored response and thus better channel model and lower error rate.

In an embodiment, the present invention provides a method for an end-to-end system for channel estimation. The method comprises: obtaining data associated with a communication system, wherein the communication system comprises a receiver, a transmitter, and a communication channel; training a neural network that models the communication channel of the communication system based on inputting the obtained data into the neural network and using a decoder, wherein the neural network produces an output indicating a probability of a signal from the communication channel; and using the trained neural network for decoding information from the communication channel. The output can indicate the probability associated with each symbol and/or the probability of the signal given a symbol or a specific sequence of symbols (e.g., p(y|s)). In other words, the output can be the probability of the symbol, more than the signal, or a better probability of the signal given the symbol. This can also depend on the decoding algorithm and will be described in further detail below.

In an embodiment, the obtained data comprises transmitted symbols, channel output, and/or starting values of the communication system.

In an embodiment, training of the neural network is based on using a gradient estimation.

In an embodiment, using the trained neural network comprises: deploying the trained neural network into the communication system to decode information from the communication channel using a minimization algorithm, wherein the minimization algorithm is based on a Viterbi method and/or other methods.

In an embodiment, the method further comprises: building, by the receiver, an ensemble of decoders associated with a plurality of communication channels within the communication system, wherein the ensemble of decoders comprises a plurality of trained neural networks that models the plurality of communication channels, and wherein using the trained neural network comprises selecting a trained neural network from the plurality of trained neural networks based on checking error correcting symbols associated with a plurality of outputs from the plurality of trained neural networks.

In an embodiment, the method further comprises: obtaining new data associated with the communication system; re-training the neural network based on the new data; and sing the re-trained neural network for the communication channel.

In an embodiment, the method further comprises: providing the trained neural network associated with the communication channel to a base station, wherein the base station shares the trained neural network with a plurality of other devices, and wherein the plurality of other devices uses the trained neural network for decoding information from the communication channel.

In an embodiment, training the neural network that models the communication channel of the communication system comprises: inputting the obtained data into the neural network to generate neural network outputs; determining decoded neural network outputs based on inputting the neural network outputs into the decoder; determining errors within the decoded neural network outputs based on a loss function; and updating the neural network based on the determined errors.

In an embodiment, using the trained neural network comprises: obtaining, by the receiver, information associated with an original message from the transmitter via the communication channel; inputting the information associated with the original message into the trained neural network to generate an output associated with the information; and decoding, using the decoder, the output associated with the information to determine a decoded message.

In an embodiment, the neural network is a standard convolutional neural network (CNN) or an auto-regressive CNN.

In an embodiment, training the neural network that models the communication channel of the communication system comprises: training a variational auto encoder (VAE) that comprises an encoder neural network and a decoder neural network, wherein the encoder neural network generates an output that is provided to the decoder neural network, and wherein an output of the decoder neural network is provided to the decoder.

In an embodiment, training the neural network that models the communication channel of the communication system comprises: training a generative adversarial neural network (GAN), wherein the GAN comprises a neural network that reconstructs a probability of symbols for channel signals, a generative network that is used to train the decoder, and a discriminator network that provides a probability that the channel signals are probable.

In an embodiment, the method further comprises: prior to training the neural network based on the obtained data, pre-training the neural network using supervised learning.

In another embodiment, the present invention provides a system for an end-to-end system for channel estimation. The system comprises: a receiver configured to: obtain data associated with a communication system, wherein the communication system comprises the receiver, a transmitter, and a communication channel; train a neural network that models the communication channel of the communication system based on inputting the obtained data into the neural network and using a decoder, wherein the neural network produces an output indicating a probability of a signal from the communication channel; and using the trained neural network for decoding information from the communication channel.

In a further embodiment, a tangible, non-transitory computer-readable medium having instructions thereon which, upon being executed by one or more processors, alone or in combination, provide for execution of a method according to any embodiment of the present invention.

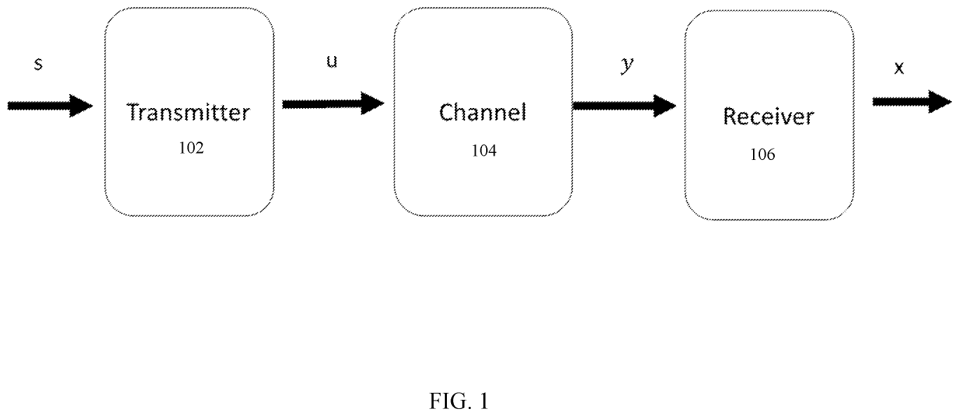

FIG. 1 schematically illustrates an exemplary communication system with a communication channel. For instance, FIG. 1 depicts a high level communication system that includes the following components a transmitter 102, a channel 104, and a receiver 106. In operation, the communication system may send information (s) from a starting location to an end location. For example, a user may use a mobile phone to communicate with a second user using a second user device. A first computing device (e.g., the first user's phone) may provide the requested information (e.g., the information denoted as (s) in FIG. 1). In some instances, the first computing device may include the transmitter 102. In other instances, the first computing device may provide information (s) to the transmitter 102 (e.g., the transmitter may be a separate entity from the first computing device). The output of the transmitter 102 is the message (u) that is to be transmitted via the channel 104 to the receiver 106. The message (u) may be based on the information (s). For instance, the transmitter 102 may encode the information (s) and the encoded information (u) is transmitted to the receiver 106 via the channel 104. The channel 104 is the medium (e.g., a communication medium) where the information is communicated from input (u) to output (y). In other words, in some instances, the channel 104 may impact the transmitted information such that the information (u) transmitted by the transmitter 102 might not be the same as the information (y) that is received by the receiver 106. For instance, noise, weather, distortions, and/or other features may be present within the channel 104 such that it distorts (e.g., changes and/or alters) the original information (u). The receiver 106 may be a decoder that takes the received information (y) and outputs the decoded message (x). The goal is to have the decoded message (x) to be the same as the original message (s) (e.g., (x=s)). As will be described below, the present invention trains and/or uses one or more machine learning models/neural networks (NN) to model the channel parameters of the channel 104 in order to improve the performance and/or efficiency of the communication system (e.g., in order to reach the goal of x=s).

The channel 104 may be unknown and the present invention describes a method and system to estimate the model of the channel 104. Examples of channels 104 include, but are not limited to: radio-frequency channels used in point-to-point communication, mobile communication or satellite communication; water or elastic mediums for transmission of sound/vibration waves; and optical mediums for transmission of optical signals.

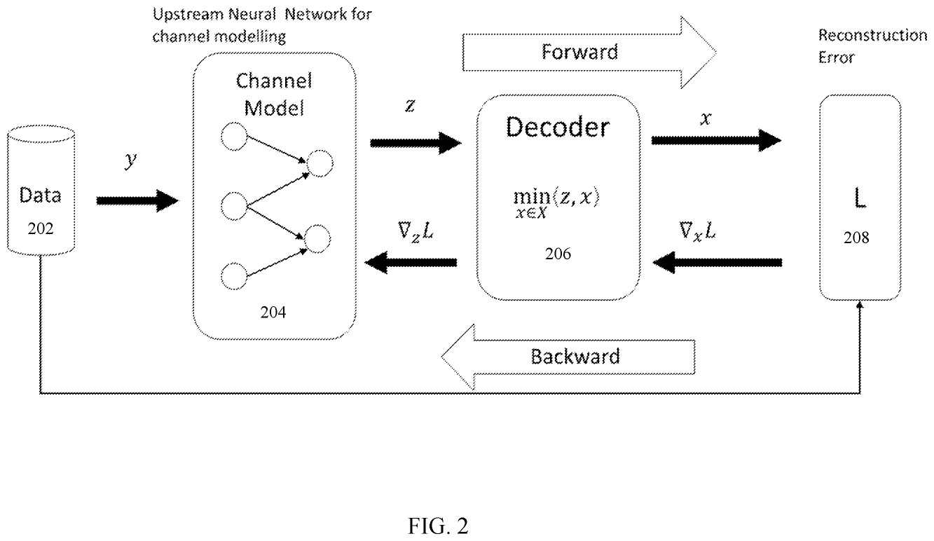

FIG. 2 schematically illustrates a method and system for training of an end-to-end communication system with a decoder 206. As shown in FIG. 2 and in embodiments of the present invention, the channel 104 is modeled using one or more neural networks (NN), while the decoder 206 solves a linear optimization problem of the form:

$${min}_{x ∈ X} 〈 z , x 〉$$

For example, the optimization solvers use the Viterbi method and/or other methods and the gradient of the optimization problem is estimated using the one step rule:

∇_{z}L≈1/τ[x(z+τ∇ₓL)−x(z)]

or

∇_{z}L≈−∇ₓL

Other gradients are otherwise computed using the chain rule and back propagated as a normal neural network system. In other words, this means that the method may be used to propagate the error using the chain rule of differentiation to compute the weights of the feed-forward network. For example, in FIG. 2, the channel model 204 may be a block with the node and edge visualization.

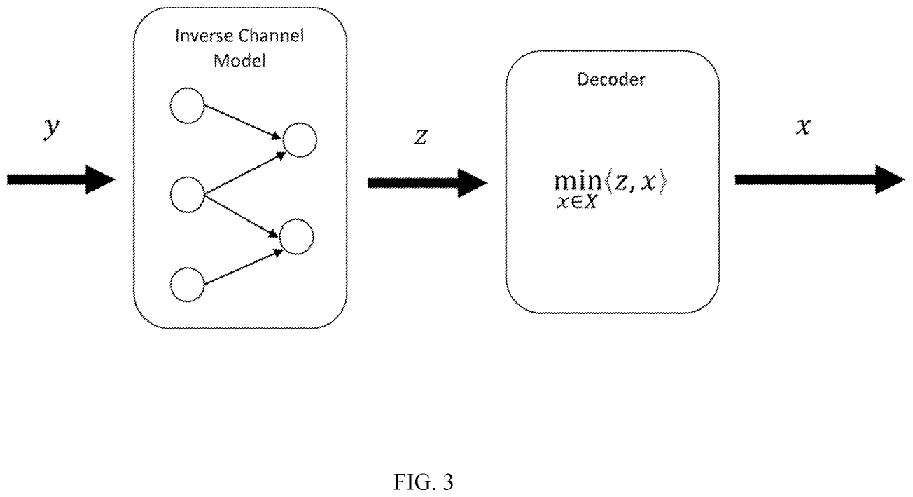

As shown in FIG. 2 (as well as FIG. 3 described below), y is the signal and z are the parameters of the decoder/receiver that are used to decode the transmitted information x. The variable y may include other information and z may be the parameter of the channel as well as also one or more probabilities that are used in the decoding algorithm. To put it another way, z are the parameters of the decoding algorithm. Referring to the above equations, ∇_{z}L is the gradient of the loss function L. The gradient may indicate how far the current NN prediction is from the true parameters, scaled by tau τ, which indicates a weight in the update of the parameters to avoid correcting too much and avoid instability in the learning process.

In other words, the channel 104 may be modeled using a NN. The NN may capture (e.g., automatically capture) short and long range relationships based on adjusting the weights of the NN. If/when additional information is available, the additional information may be incorporated without prior-knowledge of their relationship to the final channel parameters. In some instances, the signal transmitted may cover different bandwidths/frequencies and the local interaction of these subsystems may be captured by the NN. In some variations, the device may introduce distortion in the received signal and this may be incorporated into the trained NN by, for example, introducing specific parameters to model this interaction.

To put it another way, FIG. 2 shows the training phase of the end-to-end communication system, which includes data 202, a channel model/neural network 204, a decoder 206 (e.g., the receiver 106), and a loss function 208. Data (y) 202 is provided to a channel model 204 (e.g., a neural network and/or another type of machine learning model) in order to train the channel model 204. The data (y) 202 is the received signal and/or additional information available at the receiver (e.g., the location, distance to the transmitter, and so on). Based on the input data (y), the channel model 204 generates an output (z). In other words, as mentioned above, the channels (e.g., the channel 104) may be unknown (e.g., the potential interferences, noise, and/or other factors that may impact information or data as it moves through the channel might not be known) and it may be desired to model these channels in order to improve the efficiency and performance of transmitting information within the channels. For instance, due to the interference, certain bits of information may change, which leads to a higher error rate. Accordingly, a neural network is trained to represent a model of a channel (e.g., channel 104) and this model represents the potential interferences, noise, and/or other factors that may impact and/or have impacted data (y) as the data (y) passes through the channel. The output of the neural network (z) represents the data (y) after it goes through the channel model 204. In some embodiments, the channel model 204 may also capture interactions between the inputs such as time dependence and/or dependence with other information provided to the receiver.

In some instances, FIG. 1 may be the deployment phase (e.g., after training the NN) whereas FIG. 2 may be the training phase. As will be described below in the online training embodiment, these two phases (e.g., training and deployment) may be combined. But, in other embodiments, they may be two separate phases.

The output (z) is then fed into a decoder 206, which then decodes the output of the channel model 204. For instance, as mentioned above, the decoder 206 may determine the decoded information (x) based on a linear optimization problem (e.g., solving for the linear optimization problem). Then, a loss function (L) 208 is used to determine errors (e.g., the gradients such as ∇_{z}L and/or ∇ₓL) and the errors (e.g., the gradient ∇_{z}L that is determined based on the ∇ₓL) are used to update and train the channel model/neural network. For instance, the weights of the neural network 204 may be updated based on the errors from the loss function 208.

FIG. 3 schematically illustrates a method and system for deploying a trained end-to-end communication system with decoder. For instance, after the training, the communication system is used without the loss function (e.g., loss function 208) and it receives the output of the communication channel and produces the decoded messages. In other words, FIG. 3 shows the deployment phase of the end-to-end communication system with a decoder. In particular, the elements of FIG. 3 may be included within the receiver 106 shown in FIG. 1. In other words, FIG. 3 is an explanation of 106 during the deployment phase. As shown, the data (y) is fed into the inverse channel model (e.g., the trained channel model 204) to generate an output (z). The output (z) is fed into a decoder and the decoded information (x) is determined. Using the elements of FIG. 3, the efficiency of the system may be improved and there may be a reduction of the error rate. This may be due to the fact that since the transmission end-to-end is modelled with consideration of the effect of decoding, the output of the network may provide parameters to the decoder that are specific for the scenario of the received symbols, which enables the use of multiple information (e.g., multiple types of information) and without the need for a parameter search during the deployment. In contrast, traditional channel estimation may need to solve an optimization problem for every received pre-amble.

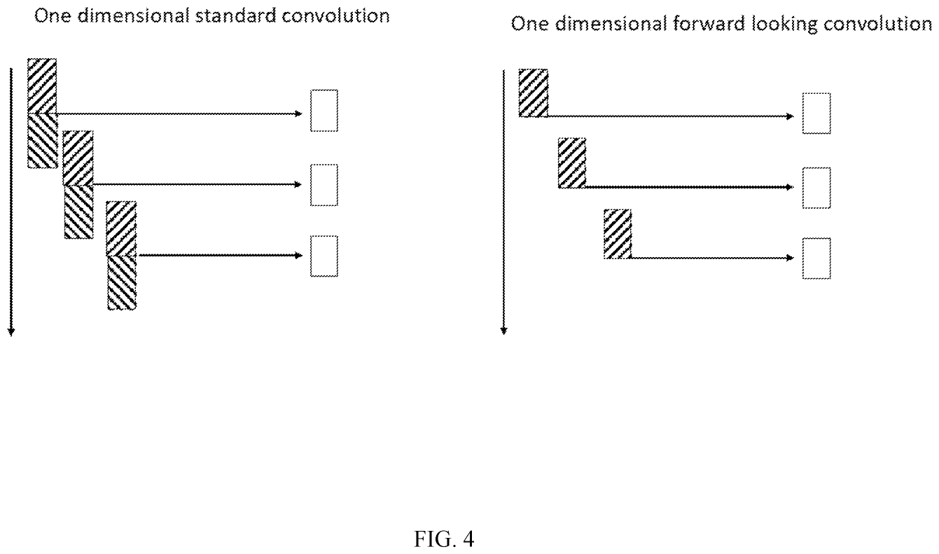

An embodiment of the present invention provides for forward convolution (auto-regressive). For example, in some instances, the channel may have limited memory. As such, the encoder (e.g., the channel model/neural network 204) may be a convolutional neural network (CNN), which in some examples, may be implemented using a looking forward model (auto-regressive). FIG. 4 schematically illustrates a forward looking (auto-regressive) network and a standard convolution network. For instance, FIG. 4 shows a forward looking (auto-regressive) network (e.g., a one dimensional forward looking convolution).

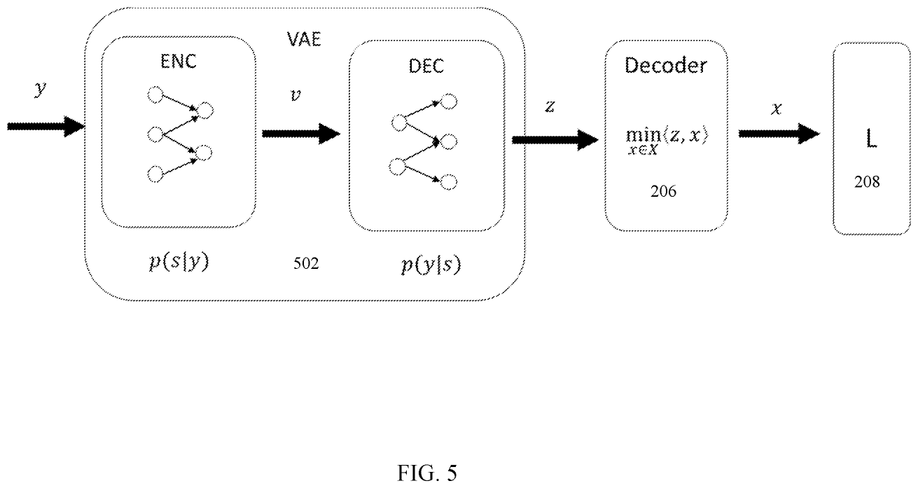

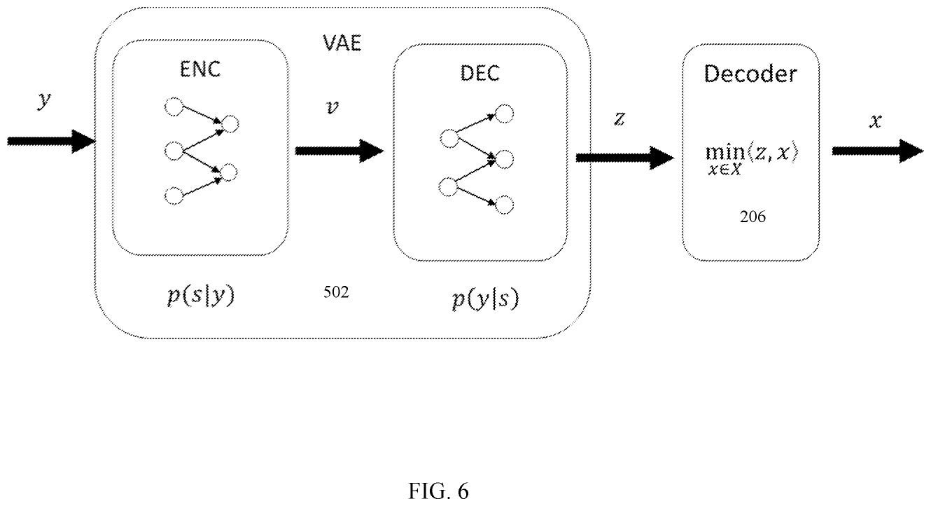

Another embodiment of the present invention provides a variational auto-encoder (VAE). FIG. 5 schematically illustrates a communication variational autoencoder (VAE) within a training environment. For instance, FIG. 5 shows the VAE 502 that includes an encoder (ENC) and a decoder (DEC), a decoder 206, and a loss function 208. FIG. 6 schematically illustrates a communication VAE during deployment. For example, FIG. 6 shows the VAE 502 and the decoder 206.

Referring to FIGS. 5 and 6, the present invention models the cost of the optimization problem as the output of the VAE 502 that models the distribution of the encoding and decoding. During training, the loss of reconstructing the symbol in the VAE 502 (the v and x variables are equivalent to the symbol s) is included in order to ask to reconstruct using training data. The system includes:
1. The encoder of the VAE 502
2. The decoder of the VAE 502
3. The decoder 206 that uses a decoding algorithm based on optimization
4. A loss function 208 that reconstructs:

a. The input symbols (x)

b. The input channel signals (v)

For example, the VAE 502 includes the encoder and the decoder. The encoder and the decoder may be one or more neural networks. The output (v) of the encoder of the VAE 502 may be provided to the decoder of the VAE 502. The VAE may be used to remove the noise from the received signal with the use of proper loss during training. The feature vector (v) may include relevant information useful for the decoding algorithm. The VAE may be used as filtering out information that is not relevant and generate one or more parameters that are useful to the decoder. The VAE is used to train part of the encoder/decoder with the input data and then train the VAE decoder to provide the signal to the decoding algorithm within the decoder 206.

P(s|y) and p(y|s) are probabilities used in the decoding algorithm (e.g., within the decoder 206). In particular, p(y|s) is used to evaluate if the current symbol was transmitted, while p(s|y) is intermediate information and is the probability of a specific symbol given the current input y. This last information might not be enough to decode due to the exponential number of symbol to decode (e.g., size of the alphabet power the length of the sequence minus the number of not valid decoding sequence given by the error correcting code). P(s|y) and p(y|s) are called the conditional probabilities. A class of decoders uses p(y|s) to decide which s has been transmitted. In other words, in operation, the present invention may seek to maximize p(y|s) over s.

During the deployment and referring to FIG. 6, the VAE 502 and the decoder 206 are used, unless training is happening at the same time. In other words, in some instances, the neural networks for the encoder and decoder of the VAE 502 may continue to be trained (e.g., updating the weights based on the loss function 508) during deployment.

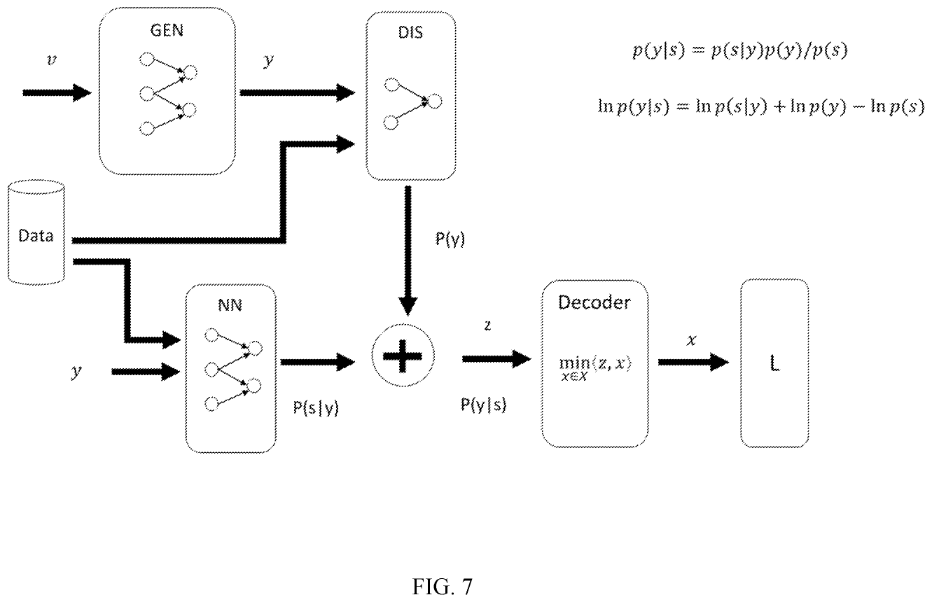

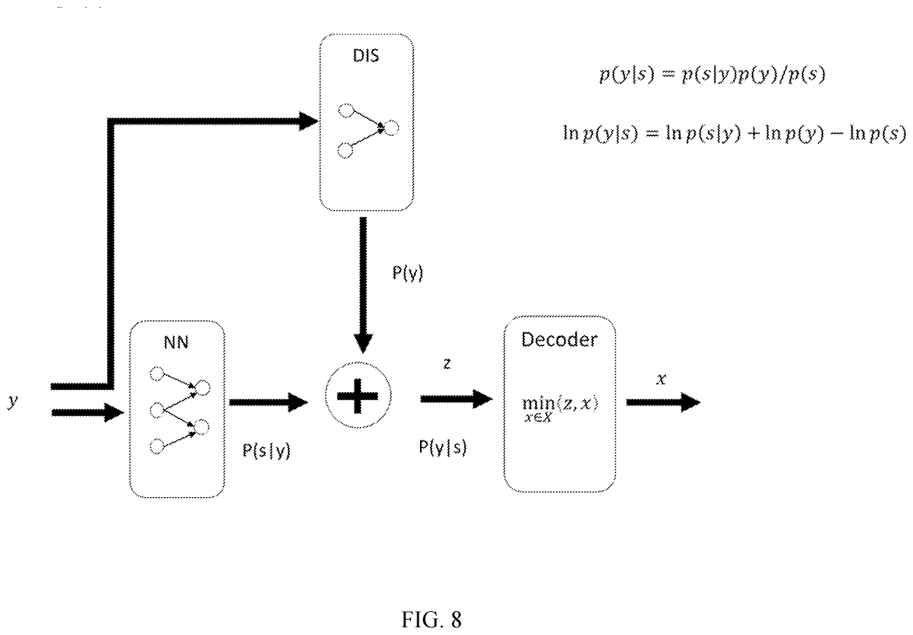

A further embodiment of the present invention provides a generative adversarial neural network (GAN). FIG. 7 schematically illustrates a method and system for training of a communication GAN. FIG. 8 schematically illustrates a method and system for deploying a trained communication GAN. Referring to FIGS. 7 and 8, the present invention considers the case where the symbol cost is computed with the use of an adversarial architecture. The system includes:
1. The generator of the GAN, the generative network is used to train the decoder
2. The discriminator of the GAN, this network provides the probability that the channel signal is probable
3. A neural network that reconstructs the probability of the symbols for the channel signals
4. The decoding algorithm based on optimization
5. A loss function that reconstructs

a. The input symbols

b. The input channel signals

In other words, FIG. 7 shows training of the communication GAN system. At deployment time, the system decodes the input channel signals (y) to the output decoded message (x). FIG. 8 shows deployment of the communication GAN system. For instance, FIG. 7 describes estimating p(y|s) from the p(s|y). In operation, it may be used to estimate p(y) separately. This information might not available and may require to sum over all possible symbols (exponential number). This may be used as an additional or alternative approach to estimate p(y|s).

In an embodiment, the present invention provides for online learning. Here, it is considered the case where the method is applied for online learning. For example, the training is locally restarted once enough data is received and decoded. This may occur when the decoder is producing correct messages. Error correcting codes may be used to decide if the received message has been correctly decoded and thus start the re-training. In other words, the receiver 106 and/or another device may determine whether the received messages are correctly decoded. Based on the determination, the receiver 106/other device may re-train the neural network/channel model (e.g., re-train the GAN, VAE, CNN, and/or other machine learning models).

In an embodiment, the present invention provides for ensemble channel models. Here, the receiver 106 may use multiple channels and thus the receiver 106 may operate in an ensemble manner. The output of the ensemble may be optimized for the current channel before restarting training. These weights may then be shared with the base station or other mobile devices/receivers.

According to an embodiment of the present invention, starting from existing traditional channel models, a model is used as a supervised learning signal to pre-train the network and then proceed with the normal training. In other words, a supervised learning method may first be used to pre-train a channel model. After, normal training (e.g., described above in FIGS. 2, 5, and/or 7) may be used to further train the channel model.

In an embodiment, the present invention provides for transfer learning. Here, pre-trained models are used to accelerate the convergence of the training phase. By using the pre-trained models, the receiver 106 may be able to more quickly adapt to new situations (dynamic channel or movement).

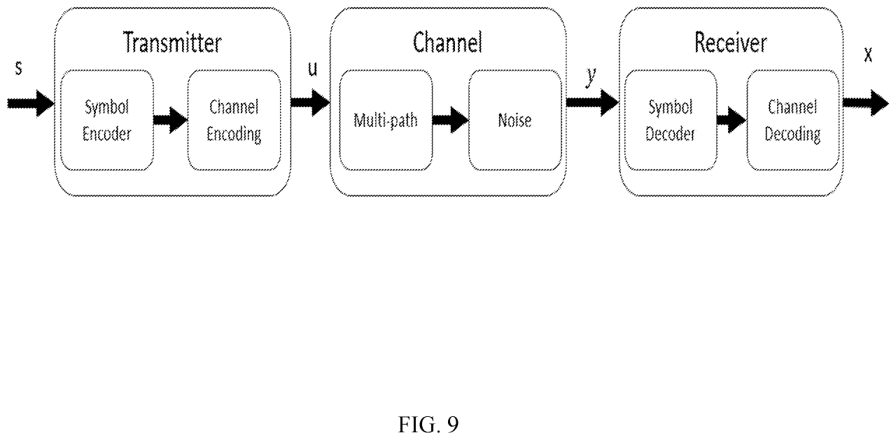

In an embodiment, the present invention provides for transmitter channel encoding and FIG. 9 will be used to describe this embodiment. In particular, FIG. 9 schematically illustrates a method and system for communication channel encoding and decoding. Here, the transmitter may also include a trainable channel pre-coder modeled as a neural network that may be used to improve performance and is also trained using the same approach where the decoder is included in the end-to-end training and with estimation of the gradient. In other words, FIG. 9 shows channel encoding and decoding using neural networks at both the transmitter as well as the receiver. For instance, the transmitter may train a first neural network for channel encoding and the receiver may train a second neural network for channel decoding. The training may be performed as described above. Afterwards, the transmitter and receiver may use the trained neural networks for channel encoding and channel decoding.

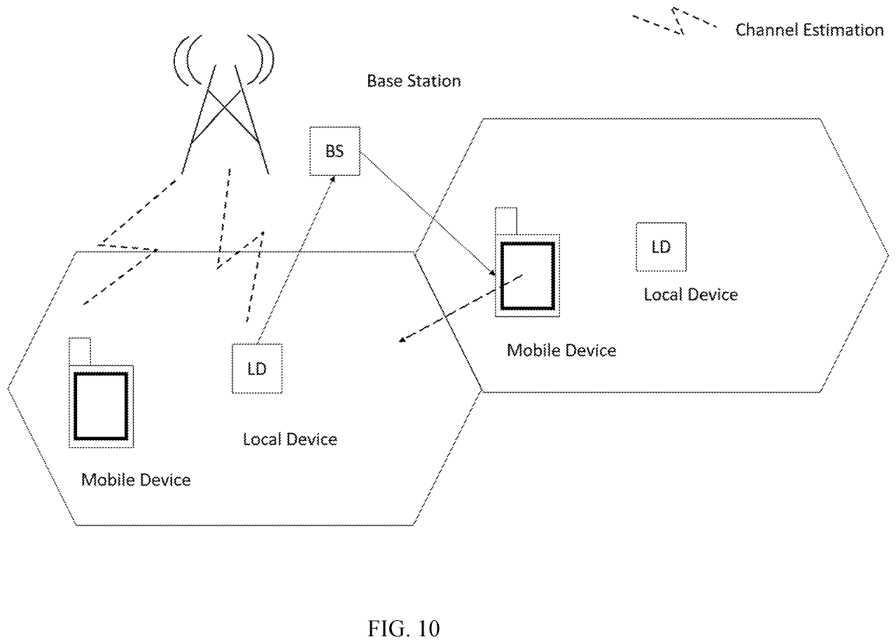

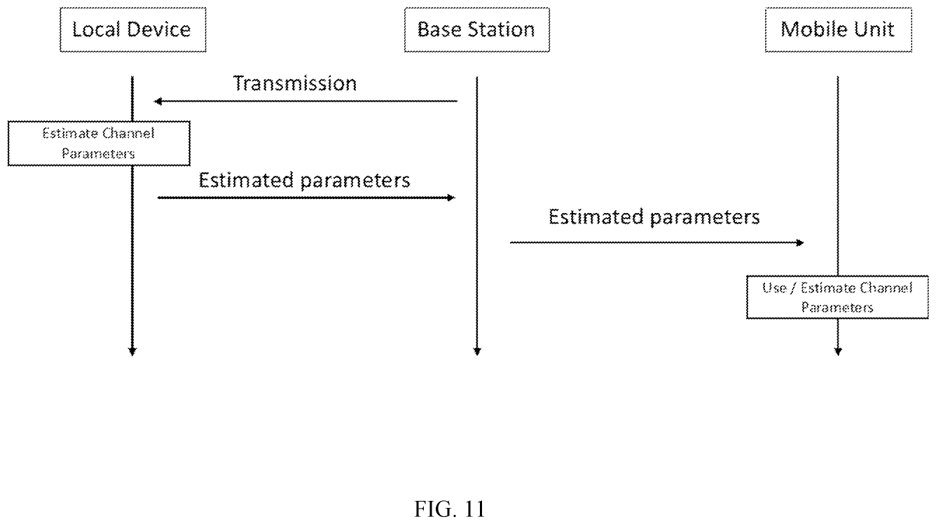

In an embodiment, the present invention provides a protocol for transfer learned models. With the previous approach (e.g., the approach shown in FIG. 9), the model of the channel may be learned and these models may be updated. This information may also be used by specialized units/devices in the network. These units/devices then may transmit to the base station the learned models that may be then distributed back to the receiver (see FIG. 9). FIGS. 10 and 11 will be used to describe this in more detail.

FIG. 10 schematically illustrates a method and system to transfer estimated channel parameters. FIG. 11 schematically illustrates an example network protocol of channel estimation. In particular, FIG. 10 shows a base station (BS) as well as local devices (LD) and mobile devices. Referring to FIG. 11, the LD may be specialized units/devices within a network. The LD may receive transmission from the BS and use the transmissions to estimate channel parameters such as by training the channel models/neural networks as described above. Then, the LD may forward the estimated parameters to the BS and the BS may forward these to the mobile units (e.g., the mobile devices). The mobile units may use/estimate the channel parameters based on the results from the local device. In other words, FIG. 10 shows a protocol to transfer estimated channel parameters. This leads to a protocol in the network to exchange the estimated parameters (see FIG. 9). FIG. 11 shows an example network protocol of channel estimation.

To put it another way, FIG. 2 shows the training phase and FIG. 10 shows an embodiment of the deployment phase. Referring to FIG. 10, a base station (BS) is shown. The LD and MD may be transmitters and/or receivers from the systems of FIGS. 1 and 3 (e.g., the uplink/downlink). FIG. 11 represents an example of the messages sent. In this case, the MD may receive the model for the receiving. If channel encoding is also implemented, then it may also receive the model for transmitting.

Embodiments of the present invention provide for the following improvements:
1. Providing a receiver end-to-end (channel+decoder) learning system that integrates one or more neural networks and a linear optimization problem (e.g., existing decoding algorithm), where the gradients of the optimization problem are estimated using the one step rule
2. Learning the channel model taking into consideration of the decoder algorithm to reduce the error rate of the transmission
3. Using existing decoding algorithm during the training of the channel model
4. Providing an end-to-end training system of channel estimation with better decoding, lower error rate and more efficient transmission
5. Providing for a shorter pilot signal with the same performance (error rate)
6. Providing for more flexible architectures to model the communication channel

In an embodiment, the present invention provides a method for predicting parameters of a transmission channel of a communication system, the method comprising the steps of:
1. Collect data: transmitted (true) symbols, channel output, possible (optional) starting values of the network (supervision, training phase, typically the receiver);
2. Train the network based on the architecture that produces the probability (p(y|s)) of the signal given the symbol from the received channel output (with the use of the gradient estimation); and
3. Use the learned parameters of the channel for decoding messages using the minimization algorithm (e.g., Viterbi method, deployment phase).

Referring to the first step, the transmitted symbols may be messages that may be transmitted from the transmitter to the receiver. They may be the ground truth data. The channel output is the information that the receiver sees when in operation. This may include the frequency signal and auxiliary information (e.g., temperature, distance to transmitter, location, and so on). The starting value of the network (e.g., the NN) are parameters that may be given from other forms of training (self-training, training in simulated environment) or previous training sessions.

Referring to the second step, z may represent the probability of the symbols within p(y|s). This information may depend on the decoding algorithm. Referring to the third step, the learned parameters may be the parameters of NN of the channel model 204 and the output z when y is received during transmission. In some instances, the learned parameters may be an output in FIG. 2 (e.g., the parameters of the NN in 204).

In some instances, the method further comprises one or more steps of the below steps of:
1. Build an ensemble (parallel) of decoders (at the receiver) using multiple channel models and select the best output, for example by checking the error correcting symbols
2. Update parameters when new training data is available (online training)
3. Send the trained model to the base station and then share with other mobile/network devices

Referring to the error correcting symbols, every time the decoder produces x (shown in FIG. 3) during deployment, the error introduced by the decoding process may be evaluated. This may be performed by encoding the symbols with an error correction code. Then, the number of errors may be estimated in the decoded message and used to select or combine a channel model. Each channel model may be the output z of multiple networks (e.g., NNs).

Embodiments of the present invention may be applied to receivers where the message specification considers a neural network and the use of a decoder that minimizes a linear cost. The design of the received decoder can be used in communication networks and associated protocols. In contrast to embodiments of the present invention, other solutions have disadvantages such as a longer pilot signal, lower throughput and a higher error rate.

In each of the embodiments described, the embodiments may include one or more computer entities (e.g., systems, user interfaces, computing apparatus, devices, servers, special-purpose computers, smartphones, tablets or computers configured to perform functions specified herein) comprising one or more processors and memory. The processors can include one or more distinct processors, each having one or more cores, and access to memory. Each of the distinct processors can have the same or different structure. The processors can include one or more central processing units (CPUs), one or more graphics processing units (GPUs), circuitry (e.g., application specific integrated circuits (ASICs)), digital signal processors (DSPs), and the like. The processors can be mounted to a common substrate or to multiple different substrates. Processors are configured to perform a certain function, method, or operation (e.g., are configured to provide for performance of a function, method, or operation) at least when one of the one or more of the distinct processors is capable of performing operations embodying the function, method, or operation. Processors can perform operations embodying the function, method, or operation by, for example, executing code (e.g., interpreting scripts) stored on memory and/or trafficking data through one or more ASICs. Processors can be configured to perform, automatically, any and all functions, methods, and operations disclosed herein. Therefore, processors can be configured to implement any of (e.g., all) the protocols, devices, mechanisms, systems, and methods described herein. For example, when the present disclosure states that a method or device performs operation or task “X” (or that task “X” is performed), such a statement should be understood to disclose that processor is configured to perform task “X”.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for an end-to-end system for channel estimation, comprising:
obtaining data associated with a communication system, wherein the communication system comprises a receiver, a transmitter, and a communication channel;
training a neural network that models the communication channel of the communication system based on inputting the obtained data into the neural network and using a decoder, wherein the neural network produces an output indicating a probability of a signal from the communication channel; and
using the trained neural network for decoding information from the communication channel.

2. The method according to claim 1, wherein the obtained data comprises transmitted symbols, channel output, and/or starting values of the communication system.

3. The method according to claim 1, wherein training of the neural network is based on using a gradient estimation.

4. The method according to claim 1, wherein using the trained neural network comprises:
deploying the trained neural network into the communication system to decode information from the communication channel using a minimization algorithm, wherein the minimization algorithm is based on a Viterbi method.

5. The method according to claim 1, further comprising:
building, by the receiver, an ensemble of decoders associated with a plurality of communication channels within the communication system, wherein the ensemble of decoders comprises a plurality of trained neural networks that models the plurality of communication channels, and
wherein using the trained neural network comprises selecting a trained neural network from the plurality of trained neural networks based on checking error correcting symbols associated with a plurality of outputs from the plurality of trained neural networks.

6. The method according to claim 1, further comprising:
obtaining new data associated with the communication system;
re-training the neural network based on the new data; and
using the re-trained neural network for the communication channel.

7. The method according to claim 1, further comprising:
providing the trained neural network associated with the communication channel to a base station, wherein the base station shares the trained neural network with a plurality of other devices, and wherein the plurality of other devices uses the trained neural network for decoding information from the communication channel.

8. The method according to claim 1, wherein training the neural network that models the communication channel of the communication system comprises:
inputting the obtained data into the neural network to generate neural network outputs;
determining decoded neural network outputs based on inputting the neural network outputs into the decoder;
determining errors within the decoded neural network outputs based on a loss function; and
updating the neural network based on the determined errors.

9. The method according to claim 8, wherein using the trained neural network comprises:
obtaining, by the receiver, information associated with an original message from the transmitter via the communication channel;
inputting the information associated with the original message into the trained neural network to generate an output associated with the information; and
decoding, using the decoder, the output associated with the information to determine a decoded message.

10. The method according to claim 8, wherein the neural network is a standard convolutional neural network (CNN) or an auto-regressive CNN.

11. The method according to claim 1, wherein training the neural network that models the communication channel of the communication system comprises:
training a variational auto encoder (VAE) that comprises an encoder neural network and a decoder neural network, wherein the encoder neural network generates an output that is provided to the decoder neural network, and wherein an output of the decoder neural network is provided to the decoder.

12. The method according to claim 1, wherein training the neural network that models the communication channel of the communication system comprises:
training a generative adversarial neural network (GAN), wherein the GAN comprises a neural network that reconstructs a probability of symbols for channel signals, a generative network that is used to train the decoder, and a discriminator network that provides a probability that the channel signals are probable.

13. The method according to claim 1, further comprising:
prior to training the neural network based on the obtained data, pre-training the neural network using supervised learning.

14. A system for an end-to-end system for channel estimation, the system comprising:
a receiver configured to:
obtain data associated with a communication system, wherein the communication system comprises the receiver, a transmitter, and a communication channel;
train a neural network that models the communication channel of the communication system based on inputting the obtained data into the neural network and using a decoder, wherein the neural network produces an output indicating a probability of a signal from the communication channel; and
using the trained neural network for decoding information from the communication channel.

15. A tangible, non-transitory computer-readable medium having instructions thereon which, upon being executed by one or more processors, alone or in combination, provide for execution of a method comprising:
obtaining data associated with a communication system, wherein the communication system comprises a receiver, a transmitter, and a communication channel;
training a neural network that models the communication channel of the communication system based on inputting the obtained data into the neural network and using a decoder, wherein the neural network produces an output indicating a probability of a signal from the communication channel; and
using the trained neural network for decoding information from the communication channel.
